(19) United States
(12) Patent Application Publication
(10) Pub. No.: US 2011/0273406 A1
(43) Pub. Date: Nov. 10, 2011

(54) Texting ring for operating the keys of keypads of cell phones and hand-held communication devices

(76) Inventor: Ron Brailey, Andover, NJ (US)

(21) Appl. No.: 12/800,121

(22) Filed: May 10, 2010

(51) Int. Cl. G06F 3/033

(52) U.S. Cl. 345/179

(57) ABSTRACT

A texting ring with attached extension arm is provided for texting messages on the key pads of a hand-held communication device. The extension arm has its proximal end attached to a ring member and its distal end extending over the key pad of the texting device. The extension arm can be pivotally attached to the ring and its proximal end and is pivotable to more than one angular position for convenience of use of texting over different keys of the key pad during texting.

### FIELD OF THE INVENTION

This invention relates generally to a device for operating the keys of a keypad of a compact communication device such as cell phone and the like, and is particularly related to a texting ring with an extension arm for texting on such keypads where the texting ring is used as an extension of a person's thumb.

### BACKGROUND OF THE INVENTION

A variety of keypad operating devices have been in common use for activating by pressing the keys on small keypads of various compact hand-held communication devices. Such communication devices include cell phones, personal computers, iPhone®, Blackberry®, personal digital assistant (PDA) and other hand-held devices with small touch screens. It is a matter of common experience that most, if not all, such devices have small screens with small keys which are too small to be pressed by the fingers of most adult users and sometimes the user may accidentally press one or more adjacent keys. Several such devices have been in and are described in some of the prior art patents. For example, U.S. Pat. Application Pub. No. US 2008/0060107 A1 published Mar. 13, 2008 discloses a thumb or finger attachment for typing on keyboards of portable hand-held devices.

U.S. Pat. No. 6,075,189 issued Jun. 13, 2000 discloses an artificial fingertip for entering commands into a personal data device by contacting its screen.

U.S. Pat. Application Pub. No. U.S. 2009/027881 A1 published Nov. 2, 2009 discloses a thumb worn tap device for use when selecting icons or keying data into a touch screen hand-held electronic device.

U.S. Pat. No. 5,885,018 issued Mar. 23, 1999 discloses a writing tool having a ring which allows the tool to be worn on the finger for writing.

U.S. Pat. No. 6,626,598 discloses an adjustable finger stylus useful in operating a touch sensitive screen.

Notwithstanding the plethora of prior art devices described in the aforementioned patents and other publications, there is still a dire need for an effective texting device which is relatively simple to construct and used to text messages on cell phones and other hand-held compact communication devices.

Therefore, it is an object of the present invention to provide a texting device for texting messages on cell phones and other hand-held compact communication devices.

It is another object of this invention to provide a texting device, such as a texting ring, which can be worn on either thumb of the user, wherein the ring has an extension arm attached thereto and is openable to press the keys on the keypad of a cell phone or a hand-held communication device.

It is also an object of this invention to provide a texting ring with a attached extension arm adapted to be tucked under the thumb when not in use, but openable to extend to press the keys on a keypad of a cell phone or a compact communication devices.

It is still another object of this invention to provide a texting right with attached extension arm which has one end pivotally connected to the ring and is openable to more than one angular position when in use.

The foregoing and other features and objects of the texting ring of this invention will be more fully understood from the following detailed description and accompanying drawings.

### SUMMARY OF THE INVENTION

In accordance with the present invention a texting ring with an attached extension arm is provided for texting messages on screens associated with cell phones, hand-held communication equipment and the like. The device of this invention comprises a ring, usually made of metal, which can be worn on the thumbs of a person, the ring having an extension arm which has a proximal end pivotally connected to the ring and which is normally tucked away under the thumb, and a distal end will open up away from the thumb and extends toward the texting screen. By providing a pivot at the proximal end, the extension arm may be opened at different angles which are convenient to the texter. Therefore, when using the texting ring of this invention, the likelihood of pressing adjacent keys on the keypad is diminished. The texting ring may be worn on the left thumb or right thumb of the texter.

### DETAILED DESCRIPTION OF THE DRAWINGS

In the drawings wherein like reference numerals are employed to designate like parts:

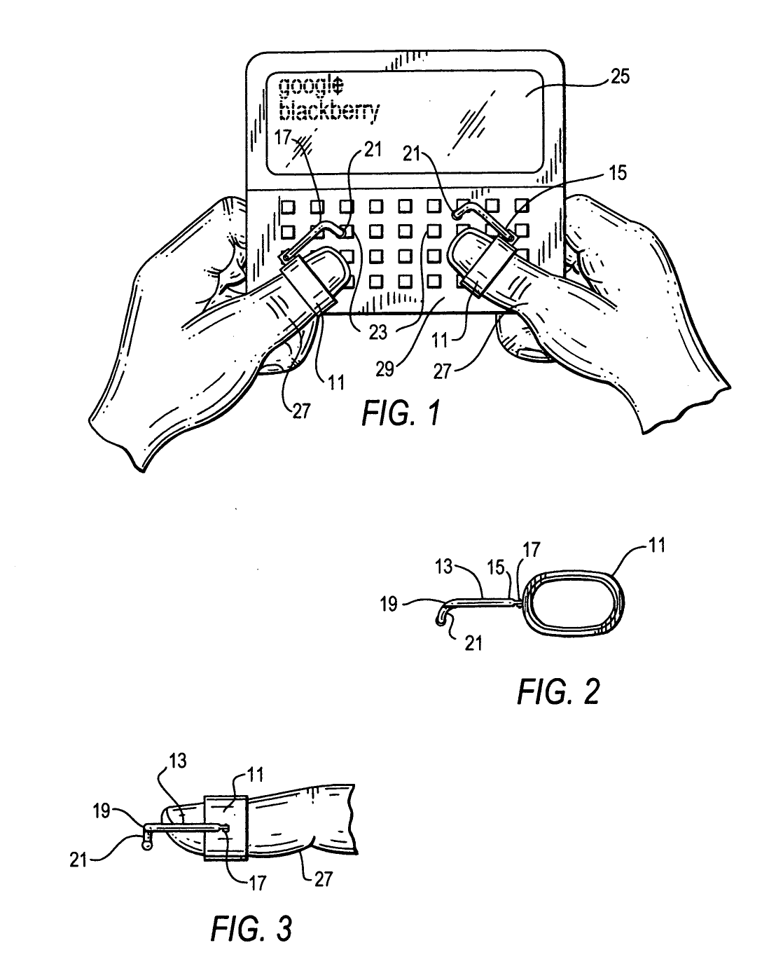

FIG. 1 is a partly perspective view of the texting rings worn on the left and right thumbs of a texter when texting messages on the keypad of a texting device;

FIG. 2 is a top view of a texting ring with attached extension arm;

FIG. 3 is a side view of a texting ring worn on the thumb of a texter;

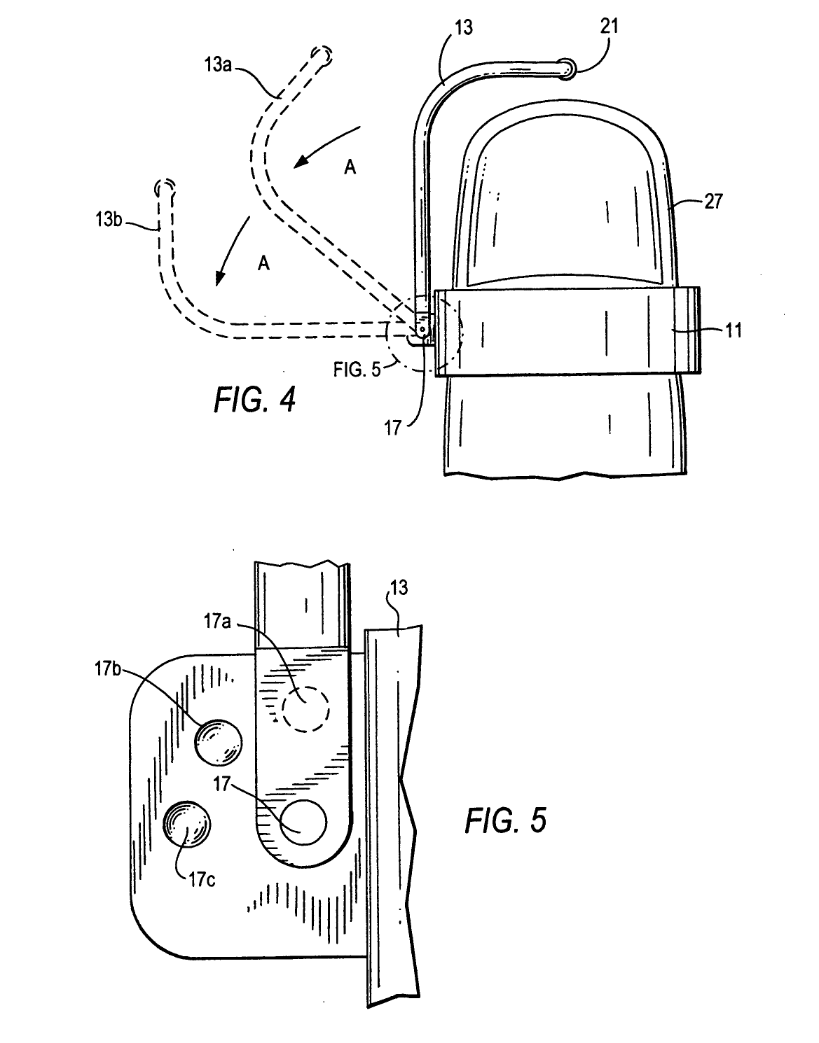

FIG. 4 is a front view of the texting ring worn on a thumb of the texter showing the extension arm pivotally attached to the ring in the phantom position;

FIG. 5 is an enlarged view of the pivot area shown in circle in FIG. 4.

### DETAILED DESCRIPTION OF THE INVENTION

Referring to the drawings, there is shown in FIG. 2 a texting ring 11 usually made of a suitable metal or a rigid plastic, which has an extension arm 13, also made of metal or rigid plastic which has its proximal end 15 connected to the ring at a pivot point 17. Extension arm 13 extends away from the texting ring and has a distal end 19 which is conveniently hooked downward as at 21 toward the keys 23 of a texting device 25, which may be a cell phone, personal computer, iPhone®, Blackberry®, personal digital assistant (PDA) and other hand-held devices with small touch screens.

As shown in FIGS. 3, 4 and 5, the texting ring 11 with the extension arm 13 attached thereto is worn on the thumb 27 of the texter. FIG. 5 shows the texting device with its keypad 29 is conveniently held by both hands of a texter, with a texting ring on each thumb 27, although only one texting ring may be used on either the left hand or the right hand. The extension arm 13 is adapted to pivot at the pivot point 17 and is normally tucked under the thumb so that it is not visible normally until it is used for texting messages on the keypad. In use, the texting arm 13 is pushed forward by the fingers so as to open the extension arm 13 to extend toward the key pad 29. FIG. 4 illustrates the use of the texting ring 11 with the extension arm 13 extending over the key pad and further shows that the extension arm 13 can be pivoted to the phantom positions 13a, 13b by pivoting about the pivot point 17 in the direction shown by the arrows A,A. The pivot point defined within the circle in FIG. 4 is shown in FIG. 5. The extension arm 13 may be biased forward so as to extend away from the ring 11, over the key pad, and may be biased to different angular positions as in 13a and 13b about the pivot points 17a, 17b or 17c.

In use, the texting ring is worn on one or both thumbs of the texter as shown in FIG. 1, and the extension arm 13 which is normally tucked under the thumb is pushed forward toward the keys of the key pad. To text a message, the tip 21 of the extension arm 13 is pressed against the desired keys on the key pad. As it can be appreciated, texting may be effected by pressing each key without pressing on the adjacent keys due to the size of the tip of the extension arm which is normally considerably smaller than the fingers of the texter.

1. A device for texting messages on the hey pad of a text screen associated with a cell phone and hand-held communication equipment, which comprises a ring member adapted to be worn on the thumb of a texter, an extension arm having a proximal end and a distal end, said proximal end being attached to said ring member and said distal end being biased away from said proximal toward said key pad of said texting screen.

2. A device as in claim 1 wherein said distal end of said extension arm is angled downward toward said key pad of said text screen.

3. A device as in claim 1 wherein said extension arm is pivotally connected to said ring member and is biased away from said proximal end toward said key pad of said text screen.

4. A device as in claim 2 wherein said extension arm is pivotally connected to said ring member and is biased away from said proximal end toward said key pad of said text screen.

5. A device as in claim 1 wherein said proximal end of said extension arm is pivotally connected to said ring member to thereby bias said extension arm to more than one angular position over said key pad of said text screen.

6. A device as in claim 2 wherein said proximal end of said extension arm is pivotally connected to said ring member to thereby bias said extension arm to more than one angular position over said key pad of said text screen.

7. A device as in claim 3 wherein said proximal end of said extension arm is pivotally connected to said ring member to thereby bias said extension arm to more than one angular position over said key pad of said text screen.

8. A device as in claim 4 wherein said proximal end of said extension arm is pivotally connected to said ring member to thereby bias said extension arm to more than one angular position over said key pad of said text screen.

9. A device as in claim 1 wherein said ring member is made of metal.

10. A device as in claim 2 wherein said ring member is made of metal.

11. A device as in claim 3 wherein said ring member is made of metal.

12. A device as in claim 4 wherein said ring member is made of metal.

13. A device as in claim 5 wherein said ring member is made of metal.

14. A device as in claim 6 wherein said ring member is made of metal.

15. A device as in claim 7 wherein said ring member is made of metal.

16. A device as in claim 8 wherein said ring member is made of metal.
